(19) United States
(12) Patent Application Publication
(10) Pub. No.: US 2018/0068248 A1
(43) Pub. Date: Mar. 8, 2018

(54) METHOD AND SYSTEM FOR ATTRIBUTING AND PREDICTING SUCCESS OF RESEARCH AND DEVELOPMENT PROCESSES

(71) Applicants: Lawrence Fu, San Diego, CA (US); Konstantinos (Constantin) Aliferis, Minneapolis, MN (US)

(72) Inventors: Lawrence Fu, San Diego, CA (US); Konstantinos (Constantin) Aliferis, Minneapolis, MN (US)

(21) Appl. No.: 14/623,428

(22) Filed: Feb. 16, 2015

(51) Int. Cl. G06Q 10/06

(52) U.S. Cl. CPC G06Q 10/06375; G06Q 10/067; G06Q 10/0635

(57) ABSTRACT

A system and method for identifying critical positive and negative factors for the success of a research and development activity.

### BACKGROUND OF THE INVENTION

This application claims priority from provisional application 61/940,727, filed 17 Feb. 2014.

### FIELD OF THE INVENTION AND BRIEF DESCRIPTION OF RELATED ART

Research and Development (R&D) are investigative activities that a business or other organizations conduct with the intention of making discoveries that can either lead to the development of new products or procedures, or to improvement of existing products or procedures. R&D may proceed in linear or non-linear manner and typically involve several steps over long periods of time.

Every field of industry engages in extensive efforts of Research and Development for New Product Development. In many industries, such R&D may last for years or decades and costs may reach or exceed the multi-billion dollar range (as for example in Pharmaceutical development, Defense and other fields of application). A major problem in managing such R&D is that of optimally allocating resources to competing R&D activities since it is not generally known which research activities are most likely to “convert” to scientific-technological results that facilitate new products. Another problem is to accelerate the successful R&D efforts and eliminate the unsuccessful ones as early as possible.

For example in the Life Sciences, the process of “Translational Research” describes the research activities that eventually lead to practical applied innovations such as new diagnostic technologies/products, new drugs, improvements in the guidelines that determine the standard of care etc. Both private industry (e.g., Pharmaceutical companies) and the public sector (e.g., Federal Funding agencies such as the NIH) are faced with the pressing problem of allocating limited resources to a small number of efforts out of many candidate R&D initiatives. In many cases, one has to decide which R&D programs that have yielded partial results should be prioritized over other incomplete or yet-to-begin ones. In addition, since the time-to-market directly affects profitability (e.g., at the tune of>1 billion USD/year for “blockbuster” drugs), it is highly desirable to accelerate the R&D that is likely to be successful and eliminate the R&D that is likely to be unsuccessful as early as possible.

The same considerations are true for all industries where R&D plays a significant role in New Product Development (NPD). Examples include: electronics, telecommunications, computer and information technology, defense, aeronautics, aviation and aerospace, Internet commerce, financing and investing, energy, automotive and transportation, marketing and advertising to name a few.

The present invention provides a method, process and apparatus for:
a. Designating high impact and low impact milestones in the R&D process for NPD.
b. Predicting the future likelihood that a particular stage of R&D may lead to conversion to a successful outcome in the R&D chain.
c. Identifying critical positive and negative factors that affect eventual R&D success or failure.

Users of the invention may use it for:
i. Understanding the enablers of fast/successful R&D and the obstacles to fast/successful R&D so that R&D practices, processes and management can be improved upon.
ii. Improving resource allocation to competing R&D activities such that research activities that are most likely to “convert” to scientific-technological results that facilitate new products are preferentially funded and ones that are likely to fail are preferentially de-funded.
iii. Accelerating the time horizon of R&D efforts that are likely to be successful and shortening the time invested on R&D that is likely to be unsuccessful.
   The invention employs methods and techniques from mathematical modeling (Markov Processes), Statistics and Machine Learning (Predictive modeling), Scientometrics, and Network Science (Dependency and Influence Graphs).

### BRIEF DESCRIPTION OF THE FIGURES AND TABLES

FIG. 1 depicts, in the Translational Research Field of Application, the citation path tracing translational success in the scientific literature from the initial basic science discovery until a clinical endpoint.

FIG. 2 depicts a possible set of Markov Process states and transitions in the Translational Research Field of Application. This set is not intended as an exhaustive or definitive list.

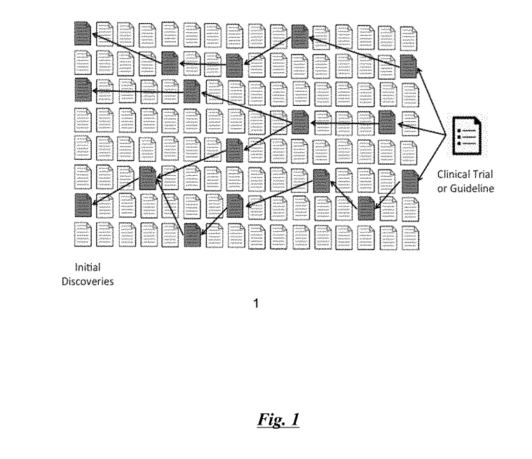

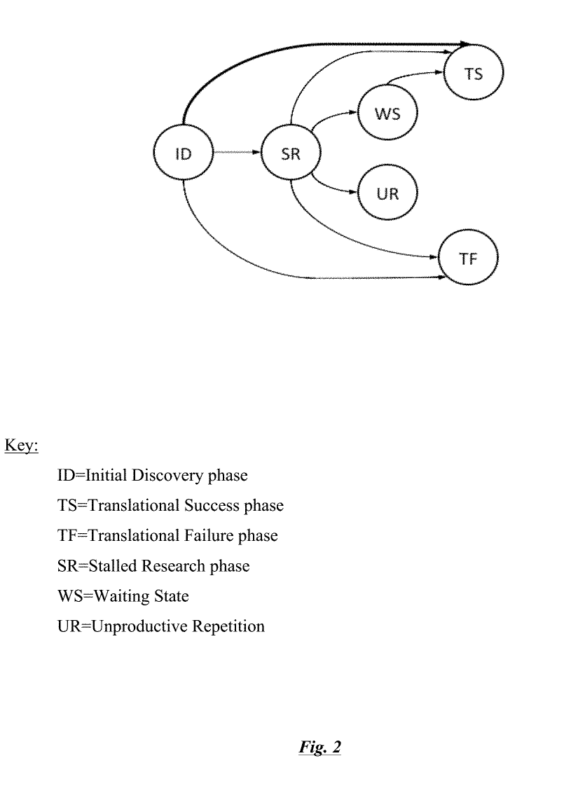

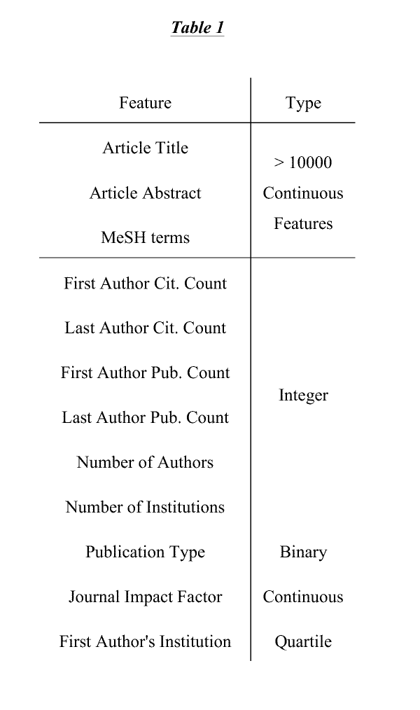

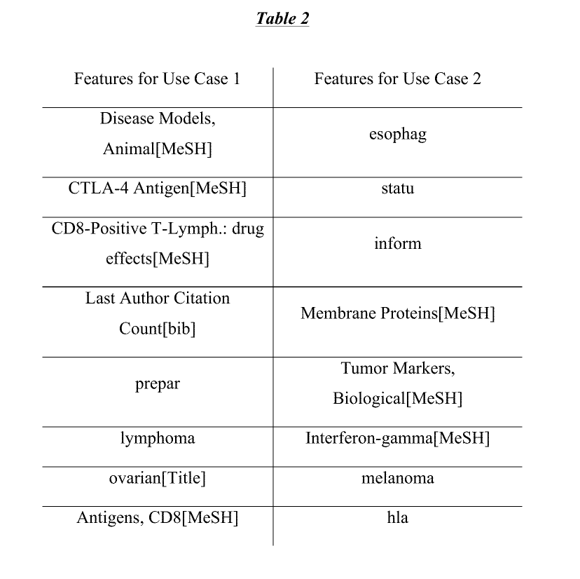

Table 1 lists example input features for Model Training in the Translational Research Field of Application. These features can either be content-based or meta-data (e.g., bibliometric) features. Content features are based on document content such as the title or abstract. Bibliometric features are information based on the authors, publication, or other metadata.

Table 2 lists the top 10 important features for two use cases with different training corpora in Translational Research Field of Application.

### DETAILED DESCRIPTION OF THE INVENTION

The invention method comprises 3 stages, which are implemented in the system described and claimed.

### I. Knowledge Base Creation & Configuration to the Specific Field of Application

Creating this Knowledge Base involves the following elements:

### 1. Units of Prediction That are of Interest to Users and Appropriate to the Field of Application.

For example, in the domain of life sciences R&D, an appropriate unit of prediction may be the stage of research toward a new drug as evidenced by development and publication of basic science or clinical findings. The unit of prediction will typically be a complex relationship of objects; for example in drug development it can be the usefulness, applicability or potential of a particular molecule for a safe and efficacious new drug.

### 2. An Instrumental Set of “Endpoint Exemplars”

that constitute or represent archetypes or milestones of success of the R&D process. In the new drug development example, these may be clinical trials that prove the improved efficacy or safety of a new drug over the best drugs currently in market.

### 3. A Dependency/Influence Network Representation of Instrumental Influences Among Stages of R&D Appropriate to the Field of Application.

In the drug development example, such a network can be a citation graph among articles, websites and patents that indicate how various molecules, pathways, assaying technologies etc. gradually support the development of a new drug. The nature of influences in the Dependency Network may vary dramatically among distinct fields of application and needs be tailored accordingly. Appropriate networks include citation influences in a citation network of articles or web pages, causal relationships in a causal graph, information transfer relationships in an information network, resource input relationships, or any other appropriate network representation of how stages of R&D influence and depend on one another.

### II. Ex Post Facto R&D Success Model and Corresponding Decision Support System

Creating this model and decision support system involves the following elements:
a. Initialize an empty working dependency graph model and add to it the “endpoint exemplar” set from the knowledge base.
b. Add to the working graph, going back in order of influence from the endpoint exemplars to the most immediate influencing objects, recursively.
c. Stop when no more dependency relationships exist in the knowledge base or when the knowledge base is exhausted.

The model can now be used to assess retroactively (i.e., “historically”) the impact of a stage of R&D to successful endpoints by using standard graph algorithms for determining all paths from a stage or stages of interest to one or more success exemplars of interest. Existence of one or more paths is direct evidence for the impact of a stage of R&D to the success of the overall effort, lack thereof is evidence for lack of impact. Other ways to describe and infer macro properties of the R&D process modelled by the graph model and identify critical components include a variety of standard Network Science analytics tools (e.g., clustering coefficient, hubs, percent shortest path, characteristic path length, Betweeness Centrality, clusters etc.)

### III. Prospective Predictive R&D Success Model and Corresponding Decision Support System

Creating this model and decision support system involves the following elements:
a. Markov Process Explicit R&D Success Model.
This model provides a granular description of sub-stages of R&D success, for example specific progress transitions from user-defined and field application specific sub-stages. In the drug development example, such stages may be stage transitions where a basic science discovery immediately leads to a new drug, or conversely stays “dormant” (or unnoticed by the scientific community) and fails to have translational impact, waiting to be picked up for later development etc.
b. Predictive R&D Success Model(s).
These models explicitly predict state transitions among the Markov Process states previously described. For example in the drug discovery domain, they may model the likelihood that a patent, announcement, or scientific article describing a new molecule may lead to an FDA-approved new drug. The state transition prediction models may involve adjacent or non-adjacent Markov Process states and may also aggregate multiple transition paths.

While construction of Markov Process models follows procedures in Decision Analysis, Operations Research and Applied Mathematics that are related to those of the prior art, the construction of predictive models uses established principles of predictive modeling highly customized for the purposes of the invention.

The steps followed include:
Data Design
Feature Selection and tuning
Classifier selection and tuning
Model Selection
Error Estimation
Model explanation, fine tuning (e.g., calibration), and analysis
Model performance optimization
Production model construction and deployment

The provided technical report (attached hereto as Appendix 1, and incorporated herein by reference) provides details of the method as applied to the specific field of application of R&D for the Life Sciences (also commonly labeled as “Translational Research”). It demonstrates empirically that the invention leads to accurate predictions and in depth understanding of R&D process in a real-life complex domain (that of translational biomedical research leading to new drug development).

### Differences from Prior Art in Predictive Modeling

Differences from General-Purpose Text Categorization and Classification Methods

### 1. Unit of Prediction.

The invention categorizes not the internal content or other de-contextualized properties of a single stage in the R&D process but a specific type of complex relationship of a single stage with the set of R&D successes. That is what is classified and predicted is the future relationship of a stage of the R&D with yet-to-be realized (possible) endpoints of R&D process, directly or through other R&D stages.

### 2. Construction of Positives and Negatives for Training of Predictive Modeling.

a. Invention incorporates the critical identification of an instrumental set of “endpoint exemplars” that implicitly provides archetypes of success of the R&D process.
b. Invention requires a dependency network representation of influences among stages of R&D. These influences may be for example citation influences in a citation network of articles, causal relationships in a causal graph, information transfer relationships in an information network, resource input relationships or other appropriate network representations of how stages of R&D influence and depend on one another.

These endpoint exemplars are NOT training exemplars for predictive modeling but need to be coupled with the dependence network that tracks paths from any stage of interest to the endpoint exemplars.

### 3. Specific Techniques and Processes for Enabling Construction of Training Corpora in Addition to Dependency Networks and Exemplar Endpoints.

These include specialized processing methods for trimming the dependency network from false positive links; specialized filtering procedures for restricting the space of all stages to stages that are most relevant to the R&D success prediction task; and a multi-level modeling approach whereby the overall transition from initiation of R&D to success or failure endpoints is modeled via a Markov Process and transition probabilities are provided by predictive modeling.

### 4. Dual Mode of Use.

a. Prospective (predictive) and
b. Retrospective (attributive) ex post facto explanatory modes of operation of the invention.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventors further require that the scope accorded their claims be in accordance with the broadest possible construction available under the law as it exists on the date of filing hereof (and of the application from which this application obtains priority, if any) and that no narrowing of the scope of the appended claims be allowed due to subsequent changes in the law, as such a narrowing would constitute an ex post facto adjudication, and a taking without due process or just compensation.

We claim as our invention:

1. A method for identifying critical positive and negative factors for the success of a research and development activity comprising the steps of:
a. creating a knowledge base configured to the technical field of the research and development activity by selecting units of prediction of interest to users and appropriate to the technical field, and an instrumental set of endpoint exemplars, and quantifying a dependency/influence network;
b. creating and/or selecting an ex post facto success model and corresponding decision support system by creating an empty working dependency graph model, and adding to the model, backward in order of influence from the set of endpoint exemplars, the most immediate influencing objects, recursively until no more dependency relationships exist or the knowledge base is exhausted; and
c. creating and/or selecting a prospective predictive success model and corresponding decision support system by explicitly identifying state transitions among Markov Process states that describe the research and development activity.

2. A system for identifying critical positive and negative factors for the success of a research and development activity comprising:
a. means for creating a knowledge base configured to the technical field of the research and development activity by selecting units of prediction of interest to users and appropriate to the technical field, and an instrumental set of endpoint exemplars, and quantifying a dependency/influence network;
b. means for creating and/or selecting an ex post facto success model and corresponding decision support system by creating an empty working dependency graph model, and adding to the model, backward in order of influence from the set of endpoint exemplars, the most immediate influencing objects, recursively until no more dependency relationships exist or the knowledge base is exhausted; and
c. means for creating and/or selecting a prospective predictive success model and corresponding decision support system by explicitly identifying state transitions among Markov Process states that describe the research and development activity.
